(19) United States
(12) Patent Application Publication
(10) Pub. No.: US 2015/0033717 A1
(43) Pub. Date: Feb. 5, 2015

(54) OCEAN BUOYANCY POWER GENERATING SYSTEM

(71) Applicant: Kuo-Hua Hsu, NEW TAIPEI CITY (TW)

(72) Inventor: Kuo-Hua Hsu, NEW TAIPEI CITY (TW)

(21) Appl. No.: 14/450,816

(22) Filed: Aug. 4, 2014

(30) Foreign Application Priority Data
Aug. 5, 2013 (TW) 102127910

(51) Int. Cl. F03B 17/06

(52) U.S. Cl. CPC F03B 17/06
USPC 60/325

(57) ABSTRACT

A ocean buoyancy power generating system includes a water inlet pipe with a water inlet, a water drawing pipe, a guiding pipe, multiple water drawing devices, a gas charging unit, an ocean power generating and collecting apparatus or ocean thermal energy conversion (OTEC) power generating and collecting apparatus, a first moving apparatus, and a second moving apparatus. Through cyclically discharging the gas to one of the water drawing devices in the water inlet pipe by the gas charging unit, buoyancy is generated on the water drawing device to continuously drive the seawater in the water drawing pipe to move upwards for electric power generation.

### FIELD OF THE INVENTION

The present invention relates to a buoyancy power generating system, and particularly to a power generating system that brings deep ocean water to above the sea level by buoyancy to generate electric power.

### BACKGROUND OF THE INVENTION

Current hydroelectric power generating systems are commonly applied in large scale power stations such as power plants and dams. A difference in water levels is usually implemented in collaboration with rotating water wheels to generate mechanical energy, which is then converted to electric energy by a power generator. However, in water storage with a dam, erosions caused by water currents below the dam are likely aggravated to lead to ecological damages. Further, in places where the amount of rainfall vastly varies, it is frequent that power generators cannot be driven due to water shortage in the event of draughts.

In view of the above issues, the Taiwan Patent No. 500874 discloses a method of electrical generation by buoyancy induced by storage of compressed air. A structure applying the method includes a pressure cylinder, a plurality of lattice air chambers for collecting air, a belt connected to the plurality of lattice air chambers, an upper transmission shaft and a lower transmission shafts sleeved around the belt, and a power generator linked with the upper transmission shaft. In the above structure, air is inputted into the air chambers spaced by water via an air outlet in communication with the pressure cylinder. However, the air chambers immediately and drastically descend when having been transported to the top by the belt. During the descent, a reverse resistive force is produced on the belt if the air is not timely discharged. As such, the belt may come to a temporary halt that causes interrupted electric power conversion. Under such interrupted electric power conversion, a power storage device or a power supply system may become unstable or even damaged.

Thus, the Taiwan Patent No. M428995 discloses a continuous gear type buoyancy power generation device including a power generation device, a buoyancy transmission device, a high pressure gas storage device and a control unit. The power generation device includes a rotating shaft and an electromagnetic transducer driven by the rotation shaft to generate electric energy. The buoyancy transmission device includes a plurality of transmission groups disposed on the rotating shaft. Each of the transmission groups includes a linkage gear for limiting rotation of the rotating shaft, and a buoyancy part connected with the linkage gear. The high pressure gas storage device includes a pressure cylinder where high pressure gas is stored and a plurality of gas outlet valves for inputting the gas to every buoyancy part. The control unit determines gas inflow and outflow of a plurality of buoyancy parts in a way that the linkage gear swings up and down to drive the rotating shaft, so that the power generation process continues and does not break.

In the above structure, the rotating shaft is linked and driven by the linkage gear to generate power for electric power generation. Thus, a larger space is needed for the buoyancy part to regard the rotating shaft as an axis and to rotate by utilizing the linkage gear as a support arm, resulting in increased costs. Further, in the above disclosure, the gas outlet valves are connected to the pressure cylinder and the buoyancy part to output gas to the buoyancy part to generate buoyancy. During back-and-forth rotations with the buoyancy part, the gas output valves are constantly bent to become liable to damages. Thus, the gas may be leaked or even the outputting process of the gas to the buoyancy part may be failed. In severe situations, the buoyancy part may fail to float, and displacements of the buoyancy part can no longer be employed to drive the rotating shaft to further drive the power generation device to generate electric power.

### SUMMARY OF THE INVENTION

The primary object of the present invention is to improve drawbacks and issues of conventional techniques. The present invention does not consume any fuels or generate wastes, air pollution, water pollution and noise pollution, and discharges nearly zero greenhouse gas (e.g., carbon dioxide) during the power generation process. Further, the present invention is capable of steadily generating electric power in all periods of the day. Moreover, the present invention generates a by-product that is fresh water that can be utilized.

To achieve the above object, a ocean buoyancy power generating system is provided. The power generating system includes: a water inlet pipe, located at ocean that is at least 500 meters below the sea level, and including a water inlet; a water drawing pipe, connected to the water inlet pipe, vertically extended out to above the sea level; a guiding pipe, disposed in parallel with and next to the water inlet pipe and the water drawing pipe; a plurality of water drawing devices, cyclically moving within the water inlet pipe, the water drawing pipe and the guiding pipe; a gas charging unit, communicating with the water inlet pipe and continuously discharging gas to one of the plurality of water drawing devices in the water inlet pipe to generate buoyancy on the water drawing device to drive seawater in the water drawing pipe to move upwards; an ocean power generating and collecting apparatus, for converting kinetic energy of the seawater moving upwards in the water drawing pipe to electric energy; a first moving apparatus, for moving the plurality of water drawing devices from a top of the water drawing pipe to a top of the guiding pipe; and a second moving apparatus, for moving the plurality of water drawing devices from a bottom of the guiding pipe to within the water inlet pipe. The gas charging unit discharges the gas to one of the water drawing devices inside the water inlet pipe to generate buoyancy on the water drawing device to drive the seawater in the water drawing pipe to move upwards into the water drawing pipe, then the first moving apparatus moving the plurality of water drawing devices from the top of the water drawing pipe to the top of the guiding pipe. After that, the plurality of water drawing devices at the guiding pipe sink to the bottom of the guiding pipe and are moved to within the water inlet pipe by the second moving apparatus, so that the gas charging unit again discharges the gas to the plurality of water drawing devices to continuously drive the seawater in the water drawing pipe to move upwards for generating electric power.

In one embodiment, the ocean buoyancy power generating system further comprises an ocean thermal energy conversion (OTEC) power generating and collecting apparatus that converts a temperature difference of the seawater moving upwards in the water drawing pipe to electric energy.

Further, the gas charging unit is a water-electrolyzing hydrogen producing apparatus, and each of the plurality of water drawing devices is an uplifting partition.

In one embodiment, the ocean buoyancy power generating system further comprises a collecting apparatus located above the water drawing pipe for collecting the gas released by the plurality of water drawing devices.

Further, the gas charging unit is in communication with the water inlet pipe via an air inlet pipe.

To achieve the above object, a ocean buoyancy power generating system is further provided. The ocean buoyancy power generating system includes: a water inlet pipe, located at ocean that is at least 500 meters below a sea level and including a water inlet; a water drawing pipe, connected to the water inlet pipe, vertically extended out to above the sea level; a guiding pipe, disposed in parallel with and next to the water inlet pipe and the water drawing pipe; a plurality of water drawing devices, cyclically moving within the water inlet pipe, the water drawing pipe and the guiding pipe; a gas charging unit, communicating with the water inlet pipe and continuously discharging gas to one of the plurality of water drawing devices in the water inlet pipe to generate buoyancy on the water drawing device to drive seawater in the water drawing pipe to move upwards; an ocean thermal energy conversion (OTEC) power generating and collecting apparatus, converting a temperature difference of the seawater moving upwards in the water drawing pipe to electric energy, a first moving apparatus for moving the plurality of water drawing devices from a top of the water drawing pipe to a top of the guiding pipe; and a second moving apparatus for moving the plurality of water drawing devices from a bottom of the guiding pipe to within the water inlet pipe. The gas charging unit discharges the gas to one of the plurality of water drawing devices inside the water inlet pipe to generate buoyancy on the water drawing device to drive the seawater in the water drawing pipe to move upwards into the water drawing pipe, then the first moving apparatus moves the plurality of water drawing devices from the top of the water drawing pipe to the top of the guiding pipe. After that, the plurality of water drawing devices at the guiding pipe sink to the bottom of the guiding pipe and being moved to within the water inlet pipe by the second moving apparatus, so that the gas charging unit again discharges gas to the plurality of water drawing devices to continuously drive the seawater in the water drawing pipe to move upwards for generating electric power.

Further, the gas charging unit is a water-electrolyzing hydrogen producing apparatus, and each of the plurality of water drawing devices is an uplifting partition.

In one embodiment, the ocean buoyancy power generating system further comprises a collecting apparatus located above the water drawing pipe for collecting the gas released by the plurality of water drawing devices.

Further, the gas charging unit is in communication with the water inlet pipe via an air inlet pipe.

The present invention features beneficial effects below. First of all, the ocean buoyancy power generating system of the present invention does not consume any fuels or generate wastes, air pollution, water pollution and noise pollution, and discharges nearly zero greenhouse gas (e.g., carbon dioxide) during the power generating process. Secondly, the ocean buoyancy power generating system of the present invention is capable of steadily generating electric power in all periods of the day. Thirdly, the ocean buoyancy power generating system of the present invention is mobile, and is thus not only extremely suitable for operations on various sea zones without any limitations, but is also free from operation complications caused by climate changes. In addition, in a preferred storage method for electric energy generated by the ocean buoyancy power generating system of the present invention, electric energy is processed by a water-electrolyzing hydrogen producing apparatus to produce hydrogen, which is the pressurized into a liquid, stored in a jar, transported to the land and converted to electric energy for further use. Further, the deep seawater obtained by the ocean buoyancy power generating system of the present invention may be treated by a desalination process. A by-product of the desalination is fresh water, which contains rich minerals and minor elements, and offers high economical values.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a side view of a system according to a preferred embodiment of the present invention; and

FIG. 2 to FIG. 9 are schematic diagrams illustrating continuous operations of FIG. 1.

### DETAILED DESCRIPTION OF THE PREFERRED EMBODIMENTS

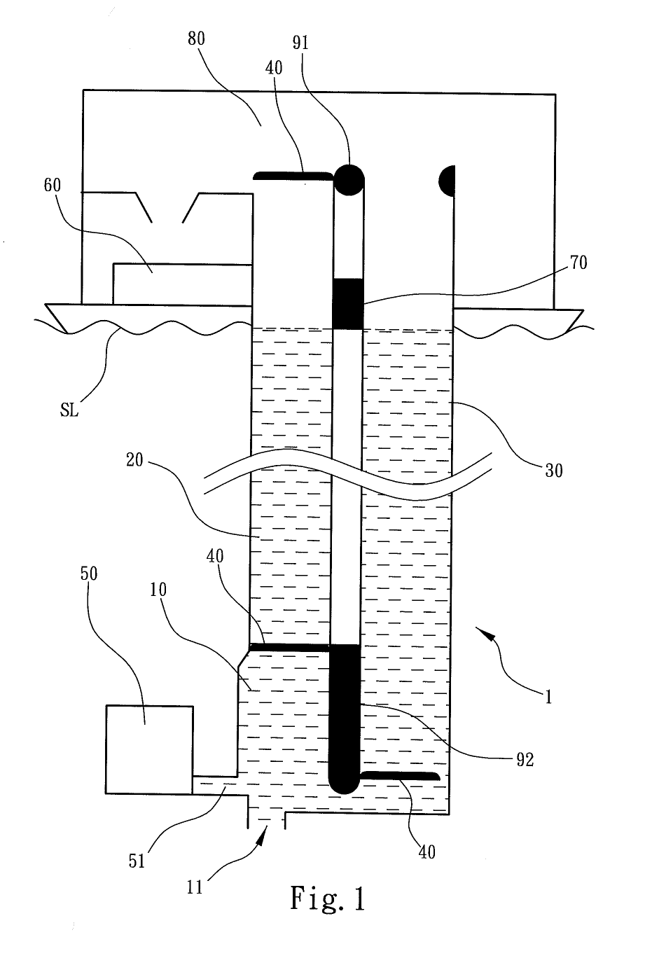

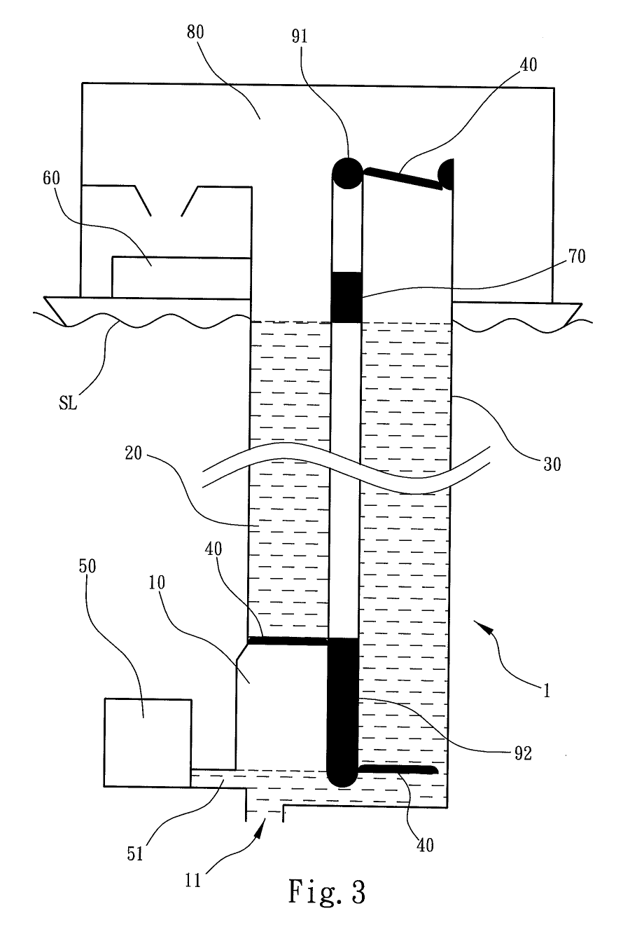

FIG. 1 shows a side view of a system according to a preferred embodiment of the present invention. To prevent from affecting denotations of symbols and lines, a seawater section line below a sea level SL and outside the present invention is omitted. As shown, a ocean buoyancy power generating system 1 of the present invention includes a water inlet pipe 10, a water drawing pipe 20, a guiding pipe 30, a plurality of water drawing devices 40 and a gas charging unit 50. The water inlet pipe 10 locates at ocean that is at least 500 meters below a sea level SL and includes a water inlet 11. The water drawing pipe 20 is connected to the water inlet pipe 10, and vertically extends out to above the sea level SL. The water inlet pipe 10 and the water drawing pipe 20 are tubes and structurally in communication with each other. Further, the water inlet pipe 10 is located in the ocean, and is connected to the water drawing pipe 20 that then vertically extends out to above the sea level SL. Further, the water drawing pipe 20 is partially revealed above the sea level SL and partially located below the sea level SL to be connected to the water inlet pipe 10 in the ocean. The guiding pipe 30 is also a tube, and has a length substantially equal to a length of the water inlet pipe 10 plus a length of the water drawing pipe 20 that are connected to be parallel to the water inlet pipe 10 and the water drawing pipe 20. Similarly, the guiding pipe 30 is partially revealed above the sea level SL and partially located below the sea level SL. The plurality of water drawing devices 40 are circularly located in the water inlet pipe 10, the water drawing pipe 40 and the guiding pipe 30. In a preferred embodiment, each of the water drawing devices 40 is an uplifting partition. However, in another embodiment, each of the water drawing devices 40 may be an inflatable apparatus. In the description below, the water drawing devices 40 are exemplified by uplifting partitions. The water drawing devices 40 are capable of moving within the water inlet pipe 10, the water drawing pipe 20 and the guiding pipe 30 mainly based on two perpetual forces in nature. One of the two perpetual forces is the buoyancy of seawater, and the other is the gravitational force that jointly drives the water drawing devices 40. In addition to cause the water drawing devices 40 to complete cyclic operations, the gas charging unit 50, a first moving apparatus and a second moving apparatus are needed to be further applied. The gas charging unit 50 is in communication with the water inlet pipe 10, and continuously discharges the gas to below the water drawing device 40 (the uplifting partition) to generate buoyancy on the water drawing device 40 (the uplifting partition). As such, the buoyancy drives seawater in the water drawing device 40 to move upwards. The gas charging unit 50 is in communication with the water inlet pipe 10 via a gas inlet pipe 51. In a preferred embodiment of the present invention, the gas charging unit 50 is exemplified by a water-electrolyzing hydrogen producing apparatus, which generates hydrogen for continuously discharging below the water drawing device 40 (the uplifting partition) to generate buoyancy. Hydrogen has an extremely small density that is about 1/14 of that of air, meaning that hydrogen is lighter than air by 14 times under the same volume. That is to say, under the same volume, the mess of those hydrogen which counteracts parts of the buoyancy is less than that of the air by 14 times, not to mention that the present invention is applied in seawater having a greater density than that of pure water. In the present invention, having achieved the buoyancy required for uplifting the water drawing device 40, a relationship of the water drawing device 40 with its periphery slidably connected to a pipe wall is utilized, such that the seawater at the top of the water drawing pipe 20 and having have an equal weight as the buoyancy is moved upwards to implement the present invention. In the description below, the gas charging unit 50 for discharging hydrogen is used for explaining an embodiment the present invention. It should be noted that, in an alternative embodiment, an air compressor that continuously discharges air to below the water drawing device 40 (the uplifting partition) may also be utilized to implement the present invention. It should be noted that in another embodiment, each of the plurality of the water drawing devices 40 is the inflatable apparatus. Therefore, the density of the water drawing device 40 is adjustable according to the amount of inflated gas. According to the law of buoyancy, the relationship between a buoyancy state and the density of the water drawing device 40 (inflatable apparatus) can be obtained. More specifically, when the water drawing device 40 is floated upwards, the buoyancy generated on the water drawing device 40 is larger than the gravitational force the water drawing device 40 asserts on the seawater; That is, the water drawing device 40 is floated upwards when its density is smaller than that of the seawater; the water drawing device 40 is afloat or adrift when its density is equal to that of the seawater; the water drawing device 40 sinks when its density is greater than that of the seawater. Further, a process of water electrolysis for producing hydrogen is a technique that electrolyzes water (electrolyte) in an electrolysis container by electricity to separate the water into hydrogen and oxygen. The electrolyte is usually alkaline water that is continuously and cyclically inputted into the electrolysis container. The electrolysis container is formed by multiple electrolysis cells connected in series. Each of the electrolysis cells is installed with anode and cathode reaction sheets with a layer of isolation membrane in between to prevent the oxygen from mixing with the hydrogen. The purity of the hydrogen produced from electrolysis may reach above 99.7%. The ocean buoyancy power generating system 1 further includes an ocean power generating and collecting apparatus 60. The ocean power generating and collecting apparatus 60 converts kinetic energy of the seawater moving upwards in the water drawing pipe 20 to generate electric power. Therefore, in the present invention, a small amount of electric power is provided to the gas charging unit 50 to produce hydrogen by electrolysis, and then hydrogen is discharged to the water drawing device 40 until giving the water drawing device 40 to float upwards. At that point, an amount of seawater having the buoyancy equal to the gravitational force in the water drawing pipe 20 is uplifted and driven upwards. Further, as the volume in the water drawing pipe 20 above the sea level SL is insufficient for accommodating the amount of the ascended seawater, the seawater naturally flows and is forwarded to the ocean power generating and collecting apparatus 60 to generate and store electric energy (referring to FIG. 3). It should be noted that, the volume and buoyancy of the hydrogen at a lower part of the water drawing device 40 are still within the water drawing pipe 20, and the seawater constantly flows and is forwarded to the ocean power generating and collecting apparatus 60. Thus, the seawater in the water drawing pipe 20 above the sea level SL cannot reach a seawater weight that can counterbalance the buoyancy of the water drawing device 40. That is to say, by discharging in a small amount of hydrogen to below the water drawing device 40 to generate enough buoyancy for moving water drawing device 40 upwards, the buoyancy can uninterruptedly drive the water drawing device 40 to uplift all the seawater in the water drawing pipe 20 to above the sea level SL. It is deduced that, even when the water drawing pipe 20 below the sea level SL has a longer length, by discharging the same amount of hydrogen as above, all of the seawater in the water drawing pipe 20 can be interruptedly driven to yield even higher power generating efficiency. The ocean buoyancy power generating system 1 further includes an ocean thermal energy conversion (OTEC) power generating and collecting apparatus 70. The OTEC power generating and collecting apparatus 70 converts a temperature difference of the seawater that moves upwards in the water drawing pipe 20 to electric energy. That is to say, when the seawater is continuously uplifted and driven upwards by the water drawing device 40, electric energy is generated and then being stored by the OTEC power generating and collecting apparatus 70. The OTEC is a type of recyclable energy, and in principle utilizes different temperatures of surface seawater and deep seawater to generate electric power. Being radiated by sunbeams, the surface seawater absorbs energy and has a higher temperature. In contrast, deep seawater beyond 200 meters below the sea level SL is barely reachable by sunbeams, and thus has a lower temperature. Therefore, the temperature of seawater generally gets lower as the depth below the sea level SL increases. In OTEC, the surface seawater having a higher temperature is heated to steam by a liquid (e.g., ammonia) having a low boiling point in a heat exchanger, forwarded to another heat exchanger and then cooled by the deep seawater, thereby completing a cycle. The ocean buoyancy power generating system 1 further includes a first moving apparatus 91 and a second moving apparatus 92. The first moving apparatus 91 moves the water drawing device 40 (the uplifting partition) from the top of the water drawing pipe 20 to the top of the guiding pipe 30. The second moving apparatus 92 moves the water drawing device 40 (the uplifting partition) from the bottom of the guiding pipe 30 to within the water inlet pipe 10. The second moving apparatus 91 and the second moving apparatus 92 are apparatuses that move the water drawing device 40 from one pipe to another pipe. Details of such moving technique are known to one person skilled in the art and can be achieved by various current moving technologies (e.g., pulleys, gears and mechanical arms). Thus, in the present invention, the water drawing device 40 can be moved by existing moving apparatuses. Further, structures of the first moving apparatus 91 and the second moving apparatus 92 are not in seek of protection of the present invention, and shall be omitted herein. It should be noted that, when the first moving apparatus 91 moves the water drawing device 40 from the top of the water drawing pipe 20 and releases the water drawing device 40 at the top of the guiding pipe 30, due to the larger density of the water drawing device 40 than that of the seawater, the water drawing device 40 naturally sinks to the bottom of the guiding pipe 30 by the gravitational force. The water drawing device 40 is then moved from the bottom of the guiding pipe 30 to the bottom of the water drawing pipe 20 by the second moving apparatus 92. Thus, the first moving apparatus 91 and the second moving apparatus 92 can be powered by the electric power generated by the ocean power generating and collecting apparatus 60 and the OTEC power generating and collecting apparatus 70. It should be noted that, the ocean buoyancy power generating system 1 further includes a collecting apparatus 80. The collecting apparatus 80 is located above the water drawing pipe 20 and collects hydrogen released from the below the water drawing device 40 (the uplifting partition). That is to say, when one of the plurality of water drawing devices 40 that drives the seawater in the water drawing pipe 20 to move upwards ascends to the sea level SL, another one of the plurality of water drawing device 40 (the uplifting partition) is further moved upwards by a next water drawing device 40 that drives the seawater in the water drawing pipe 20 to the first moving apparatus 91, which then moves the water drawing device 40 to the top of the guiding pipe 30. At this point, hydrogen below the water drawing device 40 (the uplifting partition) is immediately released to the collecting apparatus 80. Hydrogen in the collecting apparatus 80 can be again utilized and converted back to electric energy for the use of the gas charging unit 50. Alternatively, hydrogen in the collecting apparatus 80 can be directly pressurized into a liquid, stored in a jar, transported to the land and converted to electric energy for further use.

In addition to powering the first moving apparatus 91 and the second moving apparatus 92, excessive electric energy from the electric energy generated by the ocean power generating and collecting apparatus 60 or the OTEC power generating and collecting apparatus 70 may be connected by cables to on-land applications. In a preferred embodiment of the present invention, the excessive electric energy generated by the ocean power generating and collecting apparatus 60 or the OTEC power generating and collecting apparatus 70 may be provided to generate hydrogen by a water-electrolyzing hydrogen producing apparatus. Hydrogen produced is then pressurized into a liquid, stored in a jar, transported to the land and converted to electric energy for further use. Alternatively, hydrogen produced may be directly provided for the use of the gas charging unit 50. In the present invention, the gas charging unit 50 produces hydrogen by a water-electrolyzing hydrogen producing apparatus, and thus hydrogen collected by the collecting apparatus 80 may be pressurized into a liquid, stored in a jar, transported to the land and converted to electric energy for further use. Details for restoring hydrogen back to electric energy are a known technique that is not within the technical discussion of the present invention, and shall be omitted herein. For safety reasons, after pressurizing and storing the hydrogen in a jar, a location for storing the hydrogen jar is treated with certain isolation measures and kept at a distance from the ocean buoyancy power generating system 1 of the present invention. Similarly, such details are not within the technical discussion of the present invention. It should be noted that, the deep seawater from the seawater in the water drawing pipe 20 uplifted and driven by the buoyancy of the water drawing device 40 (the uplifting partition) may be treated by a desalination process. A by-product of the desalination is fresh water than can be used. Further, such fresh water contains rich minerals and minor elements, and offers high economical values.

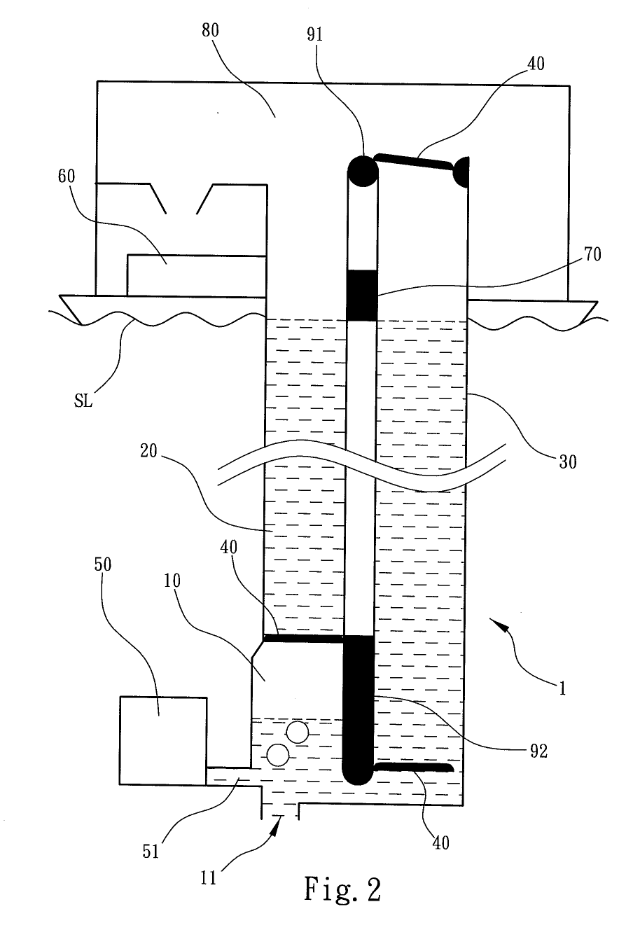

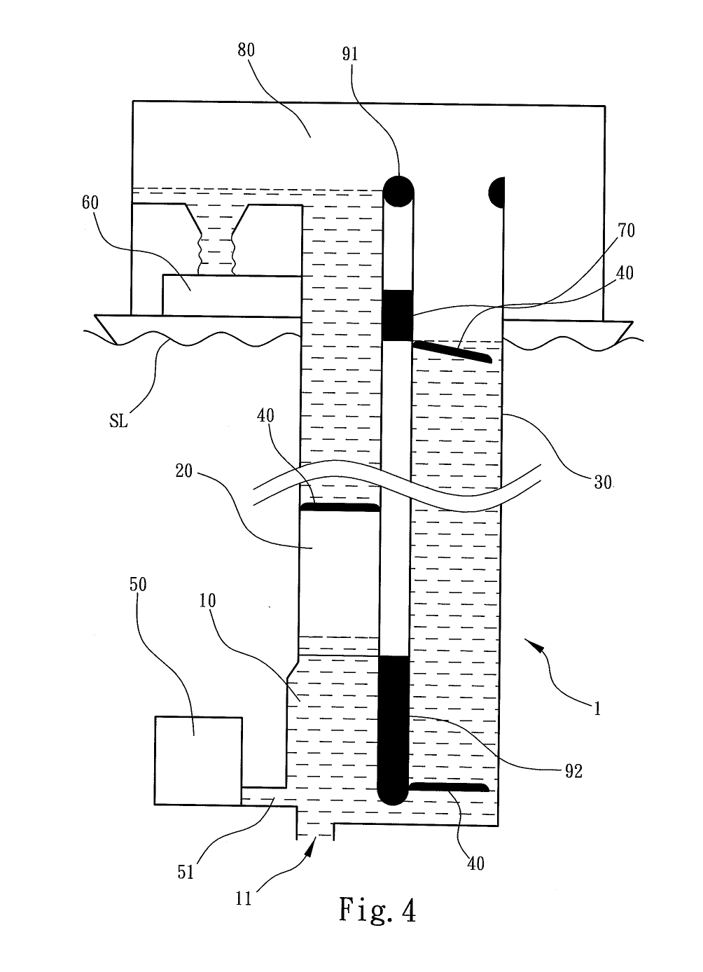

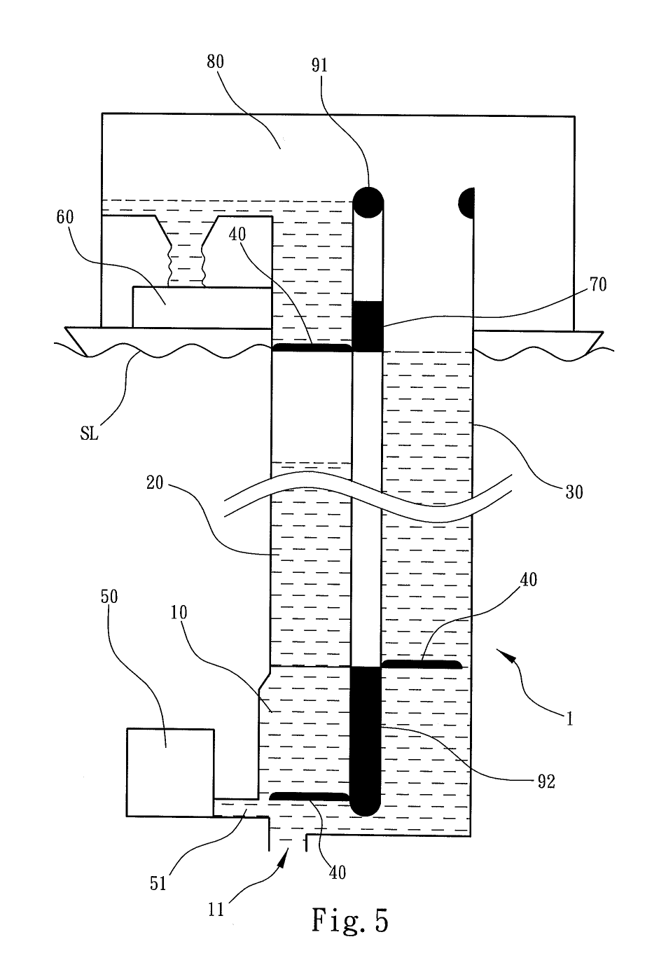

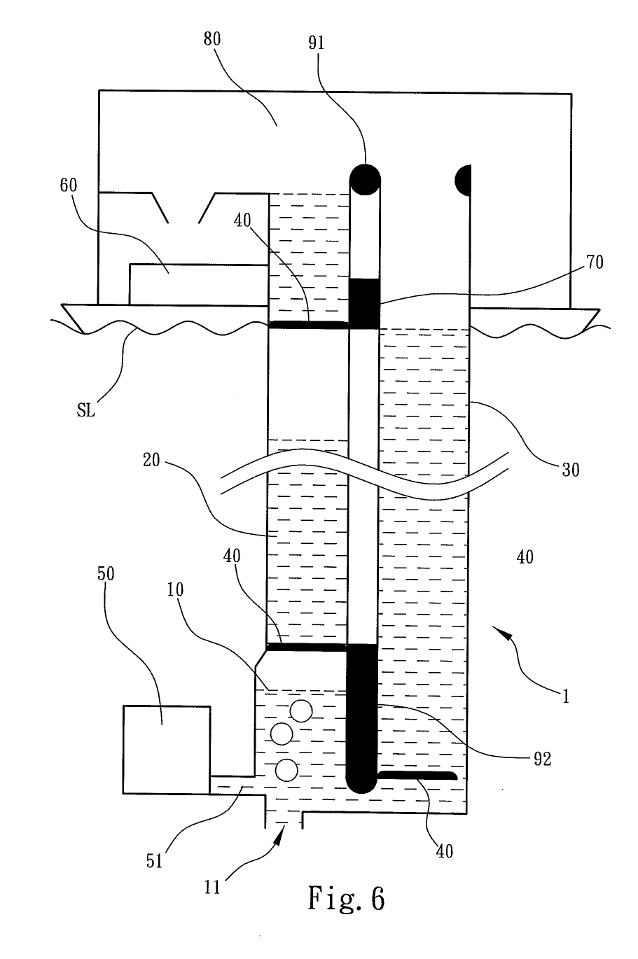

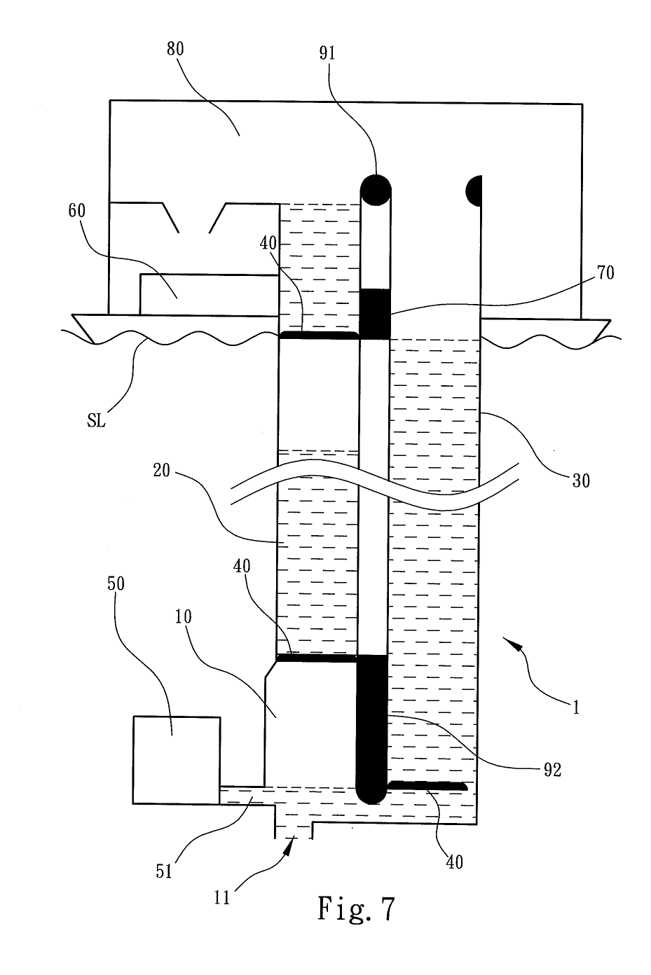

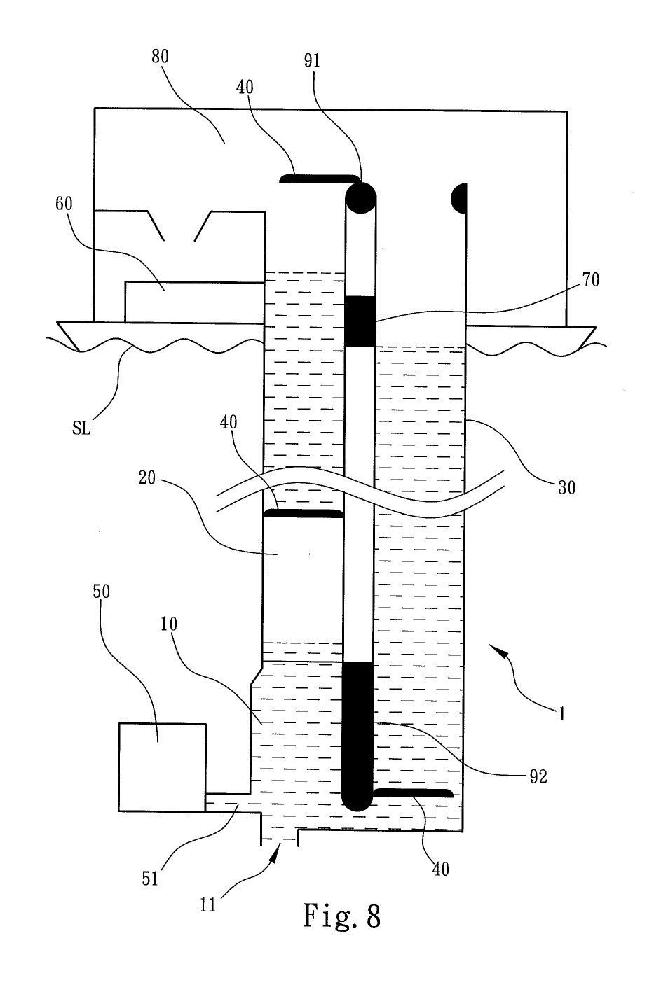

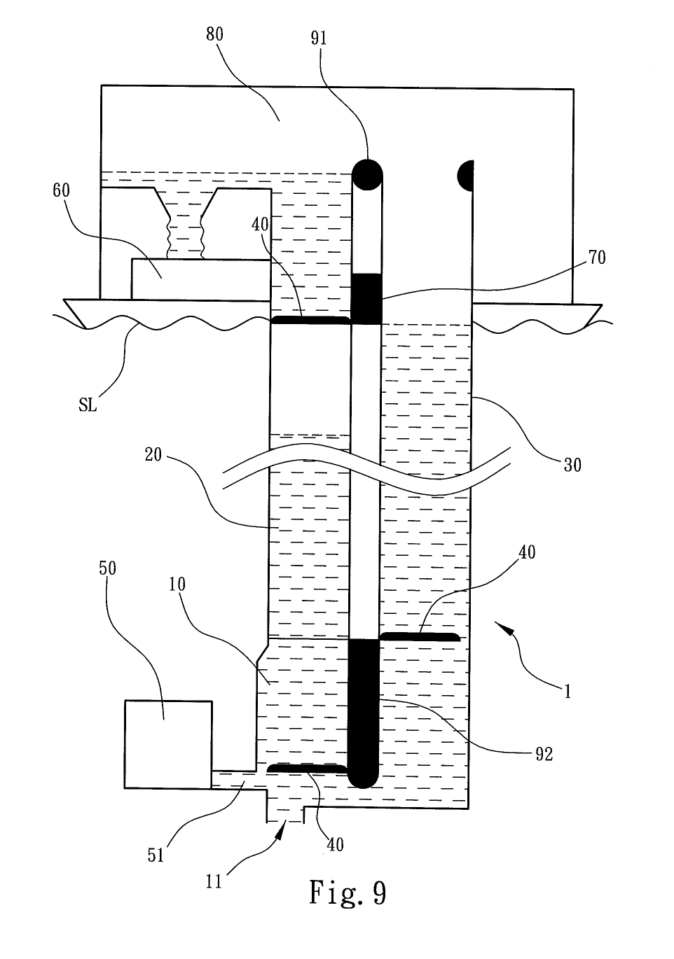

To better understand the technical contents of the present invention, continuous operations of FIG. 1 are to be described with reference to the schematic diagrams shown in FIG. 2 to FIG. 9. As shown in FIG. 2, the water drawing device 40 (the uplifting partition) is placed in from the top of the guiding pipe 30, a small amount of electric energy is provided to enable the second moving apparatus 92 to move one of the plurality of water drawing device 40 (the uplifting partition) to the top of the water inlet pipe 10, and the gas charging unit 50 is caused to start discharging hydrogen to below that water drawing device 40 (the uplifting partition). Meanwhile, other water drawing devices 40 (the uplifting partitions) are sequentially placed into the guiding pipe 30 from the top of the guiding pipe 30. The process stays at a stage where the second moving apparatus 92 controls and waits for time points for forwarding the water drawing devices 40 (the uplifting partitions) into the water inlet pipe 10, until hydrogen discharged to below the water drawing device 40 (the uplifting partition) is as shown in FIG. 3. At this point, the water drawing device 40 (the uplifting partition) is readily uplifted by the buoyancy generated from hydrogen below to drive the seawater in the water drawing pipe 20 to move upwards, as shown in FIG. 4. Thus, the seawater in the water drawing pipe 20 can be uplifted and forwarded to the ocean power generating and collecting apparatus 60 to generate electric power to be stored. Meanwhile, electric energy may also be generated by the OTEC power generating and collecting apparatus 70 and be stored. When the water drawing devices 40 (the uplifting partition) reaches the sea level SL, another water drawing device 40 (the uplifting partition) is forwarded into the water inlet pipe 10 by the second moving apparatus 92, as shown in FIG. 5. The next water drawing device 40 (the uplifting partition) is forwarded to the top of the water inlet pipe 10, and hydrogen is continuously discharged to below the water drawing device 40 (the uplifting partition), as shown in FIG. 6. When hydrogen discharged to below the water drawing device 40 (the uplifting partition) reaches a state shown in FIG. 7, the water drawing device 40 (the uplifting partition) can uplifted by the buoyancy generated from hydrogen below to drive the seawater in the water drawing pipe 20 to move upwards, as shown in FIG. 8. The previous water drawing device 40 (the uplifting partition) can be moved to the top of the guiding pipe 30 and be placed in the guiding pipe 30 by the first moving apparatus 91. Meanwhile, hydrogen below the water drawing device 40 (the uplifting partition) is immediately released to the collecting apparatus 80. Hydrogen in the collecting apparatus 80 can be again utilized and converted back to electric energy that is further stored. The seawater in the water drawing pipe 20 is continuously uplifted to the water power generating and collecting apparatus 60 to again generate electric energy to be stored, and electric energy can also be generated and stored by the OTEC power generating and collecting apparatus 70, as shown in FIG. 9. As such, the electric energy generated above can be provided to repeatedly support the cyclic operations of FIG. 6 to FIG. 9. Therefore, in an initial stage of the present invention, only a small amount of electric power needs to be inputted to generate buoyancy on the water drawing device 40, and a large amount of deep seawater can be continuously driven to above the sea level SL. The deep seawater is then uninterruptedly forwarded to the ocean power generating and collecting apparatus 60 and the OTEC power generating and collecting apparatus 70 to generate a large amount of electric energy that can be stored. Such electric energy, in addition to powering the gas charging unit 50, the first moving apparatus 91 and the second moving apparatus 92, also leaves remaining amount that can be stored for other uses. As such, in the present invention, the water drawing device 40 is ascended and descended principally by using natural forces, and excessive electric energy can be uninterruptedly generated, stored and utilized, thereby achieving the object of continuously driving the seawater in the water drawing device 40 upwards for electric power generation.

What is claimed is:

1. A ocean buoyancy power generating system, comprising:
a water inlet pipe, located at ocean that is at least 500 meters below a sea level and including a water inlet;
a water drawing pipe, connected to the water inlet pipe, vertically extended out to above the sea level;
a guiding pipe, disposed in parallel with and next to the water inlet pipe and the water drawing pipe;
a plurality of water drawing devices, cyclically moving within the water inlet pipe, the water drawing pipe and the guiding pipe;
a gas charging unit, communicating with the water inlet pipe and continuously discharging a gas to one of the plurality of water drawing devices in the water inlet pipe to generate buoyancy on the water drawing device to drive seawater in the water drawing pipe to move upwards;
an ocean power generating and collecting apparatus, for converting kinetic energy of the seawater moving upwards in the water drawing pipe to electric power;
a first moving apparatus, for moving the plurality of water drawing devices from a top of the water drawing pipe to a top of the guiding pipe; and
a second moving apparatus, for moving the plurality of water drawing devices from a bottom of the guiding pipe to within the water inlet pipe;
wherein the gas charging unit discharges the gas to one of the water drawing devices inside the water inlet pipe to generate buoyancy on the water drawing device to drive the seawater in the water drawing pipe to move upwards into the water drawing pipe, the first moving apparatus moving the plurality of water drawing devices from the top of the water drawing pipe to the top of the guiding pipe, then the plurality of water drawing devices at the guiding pipe sinking to the bottom of the guiding pipe and being moved to within the water inlet pipe by the second moving apparatus, so that the gas charging unit again discharges the gas to the plurality of water drawing devices to continuously drive the seawater in the water drawing pipe to move upwards for generating electric power.

2. The ocean buoyancy power generating system of claim 1 further comprising an ocean thermal energy conversion (OTEC) power generating and collecting apparatus that converts a temperature difference of the seawater moving upwards in the water drawing pipe to electric energy.

3. The ocean buoyancy power generating system of claim 1, wherein the gas charging unit is a water-electrolyzing hydrogen producing apparatus, and each of the plurality of water drawing devices is an uplifting partition.

4. The ocean buoyancy power generating system of claim 2, wherein the gas charging unit is a water-electrolyzing hydrogen producing apparatus, and each of the plurality of water drawing device is an uplifting partition.

5. The ocean buoyancy power generating system of claim 1 further comprising a collecting apparatus located above the water drawing pipe for collecting the gas released by the plurality of water drawing devices.

6. The ocean buoyancy power generating system of claim 2 further comprising a collecting apparatus located above the water drawing pipe for collecting the gas released by the plurality of water drawing devices.

7. The ocean buoyancy power generating system of claim 3 further comprising a collecting apparatus located above the water drawing pipe for collecting the gas released by the plurality of water drawing devices.

8. The ocean buoyancy power generating system of claim 4 further comprising a collecting apparatus located above the water drawing pipe for collecting the gas released by the plurality of water drawing devices.

9. The ocean buoyancy power generating system of claim 8, wherein the gas charging unit is in communication with the water inlet pipe via an air inlet pipe.

10. A ocean buoyancy power generating system, comprising:
a water inlet pipe, located at ocean that is at least 500 meters below a sea level and including a water inlet;
a water drawing pipe, connected to the water inlet pipe, vertically extended out to above the sea level;
a guiding pipe, disposed in parallel with and next to the water inlet pipe and the water drawing pipe;
a plurality of water drawing devices, cyclically moving within the water inlet pipe, the water drawing pipe and the guiding pipe;
a gas charging unit, communicating with the water inlet pipe and continuously discharging gas to one of the plurality of water drawing devices in the water inlet pipe to generate buoyancy on the water drawing device to drive seawater in the water drawing pipe to move upwards;
an ocean thermal energy conversion (OTEC) power generating and collecting apparatus, converting a temperature difference of the seawater moving upwards in the water drawing pipe to electric energy;
a first moving apparatus, for moving the plurality of water drawing devices from a top of the water drawing pipe to a top of the guiding pipe; and
a second moving apparatus, for moving the plurality of water drawing devices from a bottom of the guiding pipe to within the water inlet pipe;
wherein the gas charging unit discharges the gas to one of the plurality of water drawing devices inside the water inlet pipe to generate buoyancy on the water drawing device to drive the seawater in the water drawing pipe to move upwards into the water drawing pipe, the first moving apparatus moving the plurality of water drawing devices from the top of the water drawing pipe to the top of the guiding pipe, then the plurality of water drawing devices at the guiding pipe sinking to the bottom of the guiding pipe and being moved to within the water inlet pipe by the second moving apparatus, so that the gas charging unit again discharges gas to the plurality of water drawing devices to continuously drive the seawater in the water drawing pipe to move upwards for generating electric power.

11. The ocean buoyancy power generating system of claim 10, wherein the gas charging unit is a water-electrolyzing hydrogen producing apparatus, and each of the plurality of water drawing devices is an uplifting partition.

12. The ocean buoyancy power generating system of claim 10 further comprising a collecting apparatus located above the water drawing pipe for collecting the gas released by the plurality of water drawing devices.

13. The ocean buoyancy power generating system of claim 11, further comprising a collecting apparatus located above the water drawing pipe for collecting the gas released by the plurality of water drawing devices.

14. The ocean buoyancy power generating system of claim 13, wherein the gas charging unit is in communication with the water inlet pipe via an air inlet pipe.
